(19) United States
(12) Patent Application Publication
(10) Pub. No.: US 2014/0248062 A1
(43) Pub. Date: Sep. 4, 2014

(54) IMAGE FORMING APPARATUS

(71) Applicants: Toshiba Tec Kabushiki Kaisha, Tokyo (JP); Kabushiki Kaisha Toshiba, Tokyo (JP)

(72) Inventor: Junichi Katayama, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/168,122

(22) Filed: Jan. 30, 2014

(30) Foreign Application Priority Data
Mar. 4, 2013 (JP) 2013-41632

(51) Int. Cl. G03G 15/01

(52) U.S. Cl. CPC G03G 15/553
USPC 399/28

(57) ABSTRACT

According to embodiments, an image forming apparatus forms an image using at least one coloring material from among a plurality of coloring materials including a discolorable coloring material. In a case where the residual amount of any one coloring material from among the plurality of coloring materials is less than a predetermined value, a control unit of the image forming apparatus controls an image formation using another coloring material other than the coloring material of which the residual amount is less than the predetermined value.

### CROSS-REFERENCE TO RELATED APPLICATION

This application is based upon and claims the benefit of priority from the prior Japanese Patent Application No. 2013-41632, filed on Mar. 4, 2013, the entire contents of which are incorporated herein by reference.

### FIELD

Embodiments described herein relate generally to an image forming apparatus.

### BACKGROUND

An image forming apparatus that forms erasable images using a coloring material of which the color is erasable is already put into practical use. As the erasable coloring material, there is a known coloring material which becomes translucent by being heated. For example, the image forming apparatus forms an erasable full-color image using erasable coloring materials of black (BK), cyan (C), magenta (M), and yellow (Y).

The image forming apparatus cannot form an image when the coloring material is insufficient. For example, only due to a shortage of one coloring material from among the erasable coloring materials BK, C, M, and Y, the image forming apparatus stops its image forming operation.

### BRIEF DESCRIPTION OF THE DRAWINGS

FIG. 1 is a cross-sectional view illustrating main parts of an image forming apparatus according to a first embodiment;

FIG. 2A is a diagram illustrating a first screen which is displayed by a display unit of the image forming apparatus according to the first embodiment;

FIG. 2B is a diagram illustrating a second screen which is displayed by the display unit of the image forming apparatus according to the first embodiment;

FIG. 3 is a cross-sectional view illustrating main parts of an image forming apparatus according to a second embodiment;

FIG. 4A is a diagram illustrating a first screen which is displayed by a display unit of the image forming apparatus according to the second embodiment;

FIG. 4B is a diagram illustrating a second screen which is displayed by the display unit of the image forming apparatus according to the second embodiment;

FIG. 5 is a cross-sectional view illustrating main parts of an image forming apparatus according to a third embodiment;

FIG. 6A is a diagram illustrating a first screen which is displayed by a display unit of the image forming apparatus according to the third embodiment;

FIG. 6B is a diagram illustrating a second screen which is displayed by the display unit of the image forming apparatus according to the third embodiment;

FIG. 7 is a cross-sectional view illustrating the image forming apparatus according to the first embodiment;

FIG. 8 is a cross-sectional view illustrating the image forming apparatus in which a manual feed tray for an image erasing operation is mounted in the first embodiment;

FIG. 9 is a block diagram illustrating a control configuration of the image forming apparatus according to the first embodiment;

FIG. 10 is a flowchart illustrating the image erasing operation of the image forming apparatus according to the first embodiment; and

FIG. 11 is a flowchart illustrating the process of returning from an image erasing operation to an image forming operation in the image forming apparatus according to the first embodiment.

### DETAILED DESCRIPTION

According to embodiments, an image forming apparatus includes an image forming unit, a detection unit, and a control unit. The image forming unit houses a plurality of coloring materials including a discolorable coloring material, and forms an image using at least one coloring material from among the plurality of coloring materials. The detection unit detects whether the residual amounts of the plurality of housed coloring materials are less than a predetermined value. In a case where the detection unit detects that the residual amount of the discolorable coloring material from among the plurality of coloring materials is less than the predetermined value, the control unit controls an image formation of the image forming unit such that the image forming unit forms an image using another coloring material other than the coloring material of which the residual amount is less than the predetermined value.

Hereinafter, embodiments will be described with reference to the drawings. In the drawings, the same reference numerals designate the same or similar parts.

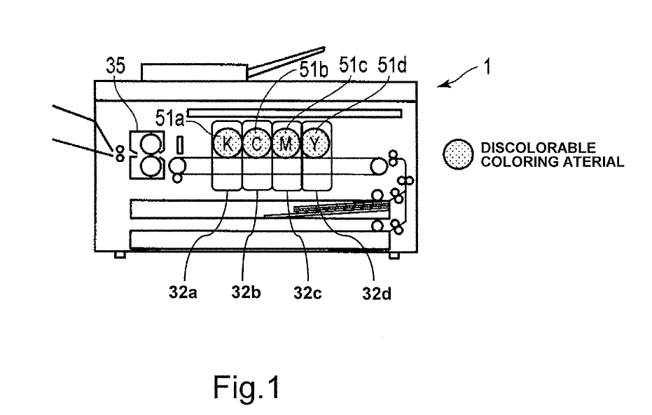

A first embodiment will be described with reference to FIG. 1. FIG. 1 is a cross-sectional view illustrating main parts of an image forming apparatus 1 according to the first embodiment. The image forming apparatus 1 is a multi-function peripheral (MFP). Hereinafter, the image forming apparatus 1 will be referred to as an MFP 1.

As illustrated in FIG. 1, the MFP 1 includes first to fourth image forming stations 32a, 32b, 32c, and 32d which form single-color images of BK (Black), C (Cyan), M (Magenta), and Y (Yellow). The MFP 1 includes a conveyance unit which conveys a recording medium, for example, a sheet to the image forming stations 32a to 32d, conveys the sheet on which the images are formed by the image forming stations 32a to 32d, and discharges the sheet outside the MFP 1.

The MFP 1 forms an image byan electrophotographic method. The image forming stations 32a to 32d form toner images on the sheet using toners as the coloring materials. The MFP 1 includes a fixing unit 35. The fixing unit 35 is disposed on the rear stage of the image forming stations 32a to 32d. The conveyance unit conveys the sheet with the toner images formed thereon to the fixing unit 35. The fixing unit 35 fixes the toner images on the sheet by heating the toner images at a predetermined fixing temperature.

The method of forming an image performed by the MFP 1 is not limited to the electrophotographic method. For example, in a case where the MFP 1 forms an image by an inkjet method, the image forming stations 32a to 32d form images on the sheet using inks as the coloring materials.

Further, the colors of the single-color images formed by the image forming stations 32a to 32d are arbitrary, and may be combined in various types depending on properties of toners and colors of inks to be used.

The four-color images formed by the image forming stations 32a to 32d of the MFP 1 according to the first embodiment illustrated in FIG. 1, in other words, the single-color images of BK, C, M, and Y are formed using toners (discolorable coloring materials) or inks (discolorable inks) under a predetermined condition. In FIG. 1, a coloring material 51a is a discolorable toner or a discolorable ink of the color BK. A coloring material 51b is a discolorable toner or a discolorable ink of the color C. A coloring material 51c is a discolorable toner or a discolorable ink of the color M. A coloring material 51d is a discolorable toner or a discolorable ink of the color Y.

An example of the predetermined condition described above is heat (temperature). The discolorable toner loses its color and is discolored by being heated at a predetermined temperature higher even than a heating temperature (a fixing temperature) of a fixing device at the time of a fixing operation.

For example, the color of the toner (the discolorable coloring material) is changed, different from the original color, by being heated at a predetermined temperature (a discoloring temperature) higher even than the fixing temperature. The different color is, for example, a transparent color. Therefore, the fixing unit 35 can make an image discolored by heating the image formed by using the discolorable toner at the discoloring temperature. Further, the discolorable toner is changed in color from the original color to a transparent color having a substantial 100% transparency by being heated at a predetermined temperature (an erasing temperature) higher even than the discoloring temperature. In other words, the discolorable toner loses its color by being heated at the erasing temperature. Hereinafter, losing a color will be referred to as decoloring. Therefore, the fixing unit 35 can make an image erased by heating the image formed by using the discolorable toner at the erasing temperature.

The discolorable ink is decolored or discolored even at the heating temperature lower than the discolorable toner based on a composition of dyes contained in the ink or the like. Another example of the predetermined condition described above is light (an ultraviolet ray or the like). The discolorable ink is decolored or discolored based on the composition of dyes contained in the ink in accordance with the irradiation of ultraviolet ray thereto or the like.

When being heated at the discoloring temperature, the toners 51a to 51d which are the discolorable coloring materials used by the MFP 1 start to be discolored. When the discolorable toners 51a to 51d are heated further to the erasing temperature, the color thereof becomes a transparent color having 100% transparency, whereby the discolorable toners 51a to 51d are decolored. Specifically, the discolorable toners 51a to 51d contain a binder resin and a pigment. The binder resin is the same as well-known toner (non-discolorable toner). The discolorable toners 51a to 51d have a feature in the pigment. The pigment includes a coloring compound, a developing agent, and a discoloring temperature regulating agent (temperature control agent). The coloring compound is a coloring agent; for example, a leuko dye is used. An example of the developing agent includes phenols. When being heated, the discoloring temperature regulating agent is compatible with the coloring compound; a material having no affinity to the developing agent is used. The discolorable toner exhibits a predetermined color when the coloring compound develops a color by interacting with the developing agent. When the discolorable toner is heated to a temperature equal to or higher than the discoloring temperature, the interaction between the coloring compound and the developing agent is weakened such that the discolorable toner starts to be discolored into a transparent color. When the discolorable toner is further heated to a temperature equal to or higher than the erasing temperature, the interaction between the coloring compound and the developing agent is disconnected such that the discolorable toner is decolored. The discoloring temperature and the erasing temperature can be adjusted by appropriately combining the discoloring temperature regulating agent therewith.

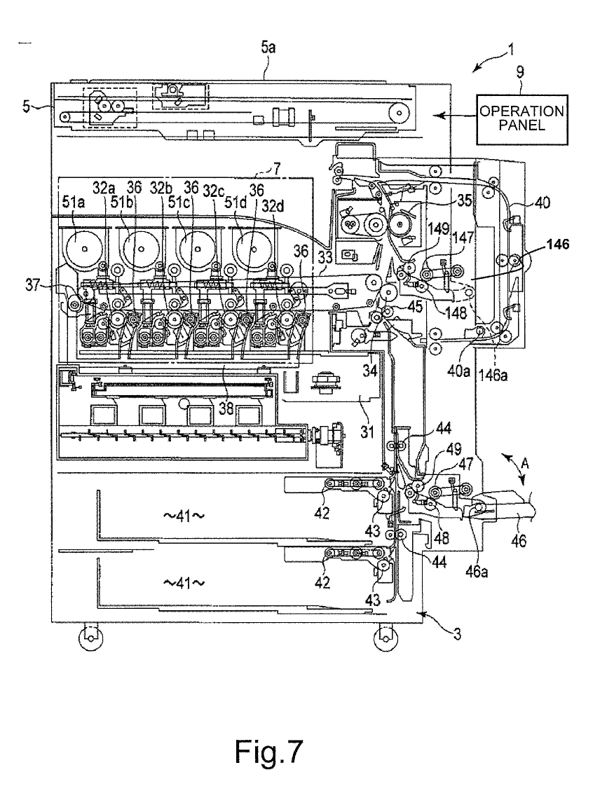

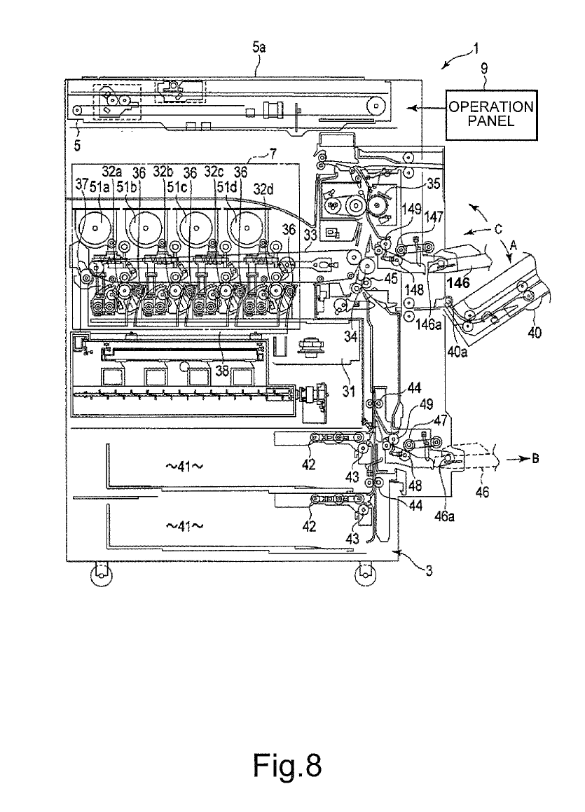

The MFP 1 according to the first embodiment illustrated in FIG. 1 will be described in detail with reference to FIGS. 7 to 9. The MFP 1 illustrated in FIGS. 7 to 9 is an example of the MFP 1 which forms a discolorable toner image by the electrophotographic method. The exterior of the MFP 1 illustrated in FIGS. 7 and 8 is slightly different from that of the MFP 1 illustrated in FIG. 1, but the same exterior may be employed.

The MFP 1 illustrated in FIGS. 7 to 9 includes at least an image forming unit 3, an image reading unit 5, an operation panel 9, and a control unit 7. The control unit 7 performs a signal processing operation and an operation control as described later. The control unit 7 is configured by a circuit substrate. The operation panel 9 includes a display unit 9a as described later. The operation panel 9 is arranged at a predetermined position of the MFP 1.

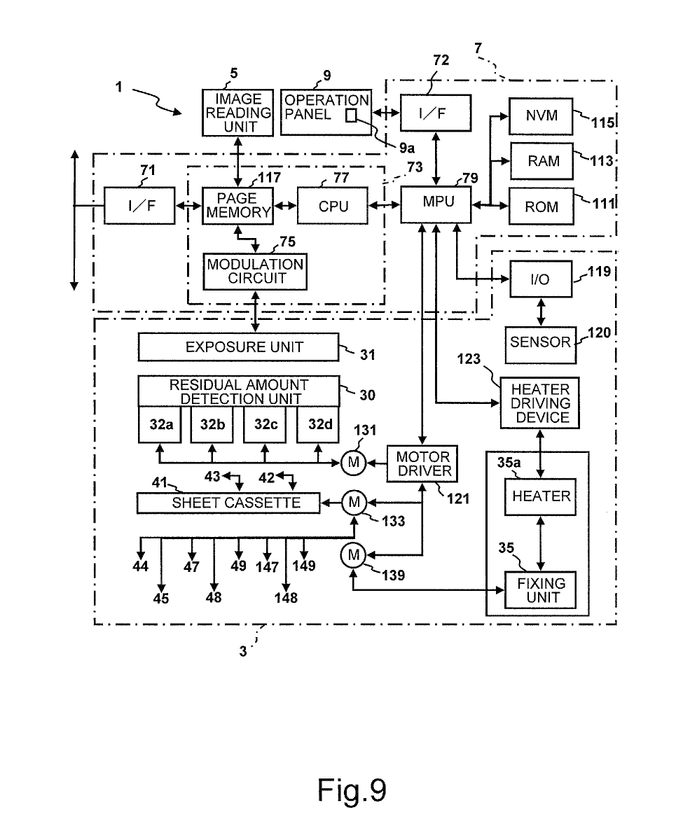

The image forming unit 3 forms a visible image (discolorable toner image), which corresponds to image data, on a paper or resin sheet. The image data may be, for example, data which is generated by the image reading unit 5, or data that is externally acquired. The image data that is externally acquired may be data that is supplied to the MFP 1 from a portable storage medium such as a semiconductor memory or data which is supplied to the MFP 1 by a supply source such as a personal computer (PC) on a network through an I/F (Interface) 71 as shown in FIG. 9.

The image reading unit 5 acquires texts and images of a document that is a reading target as shadings of light and generates image data that corresponds to the shadings.

The image reading unit 5 at least includes a document table 5a, a lighting device, and an image sensor. The document table 5a supports the document that is the reading target. The document table 5a is configured by a transparent member, for example, glass. The lighting device outputs light toward the document that is supported by the document table 5a. The image sensor converts reflected light (image information) that is reflected from the document into an image signal. The image sensor, for example, is a charge coupled device (CCD) sensor or a complementary metal-oxide semiconductor (CMOS) sensor.

The control unit 7 converts the image signal into image data that is appropriate to image formation performed by the image forming unit 3 by processing the image signal generated by the image reading unit 5. More specifically, in order to form an image, the control unit 7 performs predetermined processes such as identification of characters, a contour correction, a color tone correction (color conversion, RGB→CMY, density), a half tone (gray scale) process, and a γ characteristic (input density value vs. output density) process for an image signal supplied from the image sensor. The image signal and the image data are stored in a storage device not illustrated in the figure, for example, a hard disk drive (HDD), a semiconductor memory that can be read from the MFP 1, or the like.

The image forming unit 3 includes an exposure unit 31, the image forming stations 32a to 32d, a primary transfer unit described later, an intermediate transfer belt 33, a secondary transfer unit 34, the fixing unit 35, waste toner collecting mechanisms 36, an intermediate transfer belt cleaner 37, a waste toner recovery device 38, and the like. The fixing unit 35 serves also as a unit which performs image erasing and image discoloring.

The image forming unit 3 includes a sheet feeding unit, an aligning mechanism 45, and an ADU (Automatically Duplex Unit) 40. The sheet feeding unit includes at least one sheet cassette 41, a manual feeding tray 46, and a second manual feeding tray 146. The sheet cassette 41 houses sheets for image formation. The sheet cassette 41 is mounted to be detachably attached to a cassette mounting unit that is disposed on the lower side of the main body of the MFP 1. The image forming unit 3 includes a sheet feeding mechanism 42, a separation mechanism 43, and a conveyance mechanism 44 as conveyance units disposed for each cassette 41.

The manual feeding tray 46 holds sheets for image formation. The manual feeding tray 46 is mounted to be detachably attached to a first tray mounting unit that is disposed on the lower side of the side face of the main body of the MFP 1. More specifically, the first tray mounting unit includes a supporting point 46a. The manual feeding tray 46 is mounted to be detachably attached to this supporting point 46a. The manual feeding tray 46 mounted at the supporting point 46a can be open or closed with respect to the side face of the main body of the MFP 1 by being supported to be rotatable around the supporting point 46a as the center in a direction denoted by arrow A. In the closed state, the manual feeding tray 46 substantially adheres to the side face of the main body of the MFP 1. In the open state, the manual feeding tray 46 is separated from the side face of the main body of the MFP 1 and can hold sheets. Accordingly, in a case where the manual feeding tray 46 is used, a user can open the manual feeding tray 46 with respect to the side face of the main body of the MFP 1. When the manual feeding tray 46 is not used, the user can close the manual feeding tray 46 with respect to the side face of the main body of the MFP 1.

The image forming unit 3 includes a sheet feeding mechanism 47, a separation mechanism 48, and a timing matching mechanism 49 as conveyance units for the manual feeding tray 46. The supporting point 46a of the first tray mounting unit, the sheet feeding mechanism 47, the separation mechanism 48, and the timing matching mechanism are arranged on the front stage of the aligning mechanism 45.

The sheet feeding mechanism 47 extracts sheets from the manual feeding tray 46. The separation mechanism 48 separates the sheets extracted from the manual feeding tray 46 one by one. The timing matching mechanism 49 conveys the sheets separated one by one to the aligning mechanism 45 in accordance with the operation of the image forming unit 3.

The second manual feeding tray 146 holds a sheet for erasing an image formed on the sheet and discoloring the image. The second manual feeding tray 146 is mounted to be detachably attached to a second tray mounting unit that is disposed on the upper side of the side face of the main body of the MFP 1. More specifically, the second tray mounting unit includes a supporting point 146a. The second manual feeding tray 146 is mounted to be detachably attached to this supporting point 146a. The second manual feeding tray 146 mounted at the supporting point 146a can be open or closed with respect to the side face of the main body of the MFP 1 by being supported to be rotatable around the supporting point 146a as the center in a direction denoted by arrow A. In the closed state, the second manual feeding tray 146 substantially adheres to the side face of the main body of the MFP 1. In the open state, the second manual feeding tray 146 is separated from the side face of the main body of the MFP 1 and can hold sheets. Accordingly, in a case where the second manual feeding tray 146 is used, a user can open the second manual feeding tray 146 with respect to the side face of the main body of the MFP 1. When the second manual feeding tray 146 is not used, the user can close the second manual feeding tray 146 with respect to the side face of the main body of the MFP 1.

The image forming unit 3 includes a sheet feeding mechanism 147, a separation mechanism 148, and a timing matching mechanism 149 as conveyance units for the second manual feeding tray 146. The supporting point 146 of the second tray mounting unit, the sheet feeding mechanism 147, the separation mechanism 148, and the timing matching mechanism 149 are arranged on the rear stage of the aligning mechanism 45 and between a transfer position and the fixing unit 35. The transfer position is a position at which the intermediate transfer belt 33 and the secondary transfer unit 34 are brought into contact with each other.

The sheet feeding mechanism 147 extracts sheets from the second manual feeding tray 146. The separation mechanism 148 separates the sheets extracted from the second manual feeding tray 146 one by one. The timing matching mechanism 149 conveys the sheets separated one by one to the fixing unit 35 in accordance with the operation of the fixing unit 35.

The exposure unit 31 converts the image data output by an image processing unit 73 of the control unit 7 into the intensity of a laser light beam. The exposure unit 31 irradiates the photosensitive drums of the respective image forming stations 32a to 32d with the laser light beams which are obtained by converting the image data of the respective colors BK, C, M, and Y. The exposure unit 31 forms electrostatic latent images on the respective photosensitive drums of the respective image forming stations 32a to 32d by the irradiation of the laser light beams. The image forming stations 32a to 32d develop the electrostatic latent images using the discolorable toners of the respective colors BK, C, M, and Y, such that the discolorable toner images of the respective colors BK, C, M, and Y are formed on the photosensitive drums as the visible images.

Each of the image forming stations 32a to 32d includes the photosensitive drum which serves as an image carrier, a developing unit, and the primary transfer unit.

The photosensitive drum of the image forming station 32a is used for the formation of an image of the color BK. The photosensitive drum of the image forming station 32a generates an electrostatic latent image that corresponds to laser light, which is irradiated from the exposure unit 31, used for the formation of the image of the color BK. The developing unit of the image forming station 32a develops the electrostatic latent image by supplying discolorable toner 51a to the photosensitive drum for the formation of an image of the color BK. The developing unit of the image forming station 32a develops the electrostatic latent image, thereby forming an image of the discolorable toner 51a on the photosensitive drum for the formation of an image of the color BK. The primary transfer unit of the image forming station 32a transfers the image of the discolorable toner 51a formed on the photosensitive drum for the formation of an image of the color BK to the intermediate transfer belt 33.

The photosensitive drum of the image forming station 32b is used for the formation of an image of the color C. The photosensitive drum of the image forming station 32b generates an electrostatic latent image that corresponds to laser light, which is irradiated from the exposure unit 31, used for the formation of the image of the color C. The developing unit of the image forming station 32b develops the electrostatic latent image by supplying discolorable toner 51b to the photosensitive drum for the formation of an image of the color C. The developing unit of the image forming station 32b develops the electrostatic latent image, thereby forming an image of the discolorable toner 51b on the photosensitive drum for the formation of an image of the color C. The primary transfer unit of the image forming station 32b transfers the image of the discolorable toner 51b formed on the photosensitive drum for the formation of an image of the color C to the intermediate transfer belt 33.

The photosensitive drum of the image forming station 32c is used for forming an image of the color M. The photosensitive drum of the image forming station 32c generates an electrostatic latent image corresponding to the laser light beam which is irradiated from the exposure unit 31 for forming the image of the color M. The developing unit of the image forming station 32c supplies the discolorable toner 51c to the photosensitive drum for forming the image of M, and develops the electrostatic latent image. The developing unit of the image forming station 32c forms an image of the discolorable toner 51c on the photosensitive drum for forming the image of the color M by developing the electrostatic latent image. The primary transfer unit of the image forming station 32c transfers the image of the discolorable toner 51c formed on the photosensitive drum for forming the image of the color M to the intermediate transfer belt 33.

The photosensitive drum of the image forming station 32d serves to form an image of the color Y. The photosensitive drum of the image forming station 32d generates an electrostatic latent image corresponding to the laser light beam which is irradiated from the exposure unit 31 for forming the image of the color Y. The developing unit of the image forming station 32d supplies the discolorable toner 51d to the photosensitive drum for forming the image of the color Y, and develops the electrostatic latent image. The developing unit of the image forming station 32d forms an image of the discolorable toner 51d on the photosensitive drum for forming the image of the color Y by developing the electrostatic latent image. The primary transfer unit of the image forming station 32d transfers the image of the discolorable toner 51d formed on the photosensitive drum for forming the image of the color Y to the intermediate transfer belt 33.

In a case where a full-color image is formed, the four-color images of the discolorable toners 51a to 51d overlap each other to be transferred to the intermediate transfer belt 33.

The alignment positions of the respective image forming stations 32a to 32d, in other words, the order of forming the images of the discolorable toners 51a to 51d on the intermediate transfer belt 33 is determined according to image forming processes and toner properties.

The MFP 1 includes a plurality of housing units which house the discolorable toners 51a to 51d and supply the discolorable toners 51a to 51d to the developing units of the image forming stations 32a to 32d. The respective housing units are configured to refill the discolorable toners 51a to 51d in a case where the residual amount of any coloring material from among the housed discolorable toners 51a to 51d is insufficient. For example, the housing unit is detachably provided in the main body of the MFP 1 so as to be replaced with a new housing unit. Therefore, in a case where the residual amount of any coloring material from among the discolorable toners 51a to 51d is insufficient, a user can replace the housing unit which houses the coloring material insufficient in the residual amount; in this way, the MFP 1 is configured to be able to refill the discolorable toners 51a to 51d. The insufficiency in the residual amounts of the discolorable toners 51a to 51d is detected by a residual amount detection unit 30 to be described later.

The intermediate transfer belt 33 maintains the images of the discolorable toners 51a to 51d which are formed by the respective image forming stations 32a to 32d, and conveys the maintained images to the transfer position.

The secondary transfer unit 34 transfers the images of the discolorable toners 51a to 51d, which are conveyed by the intermediate transfer belt 33, from the intermediate transfer belt 33 to the sheet at the transfer position.

The fixing unit 35 fixes, to the sheet, the images of the discolorable toners 51a to 51d which are transferred to the sheet from the intermediate transfer belt 33 by the secondary transfer unit 34.

The discolorable toner (residual toner after the primary transfer) remaining on each photosensitive drum without being transferred from the photosensitive drums to the intermediate transfer belt 33 is removed by a cleaner (not illustrated). The waste toner collecting mechanism 36 collects the residual toner after the primary transfer which is removed by the cleaner, such that the waste toner recovery device 38 to be described later can recover the residual toner after the primary transfer. The waste toner collecting mechanism 36 collects the residual toner after the primary transfer near the primary transfer unit of each of the image forming stations 32a to 32d.

After the secondary transfer of the secondary transfer unit 34, the discolorable toner (the residual toner after the secondary transfer) which is not transferred to the sheet remains on the intermediate transfer belt 33. The intermediate transfer belt cleaner removes and collects the residual toner after the secondary transfer from the intermediate transfer belt 33, such that the waste toner recovery device 38 to be described later can recover the residual toner after the secondary transfer. The intermediate transfer belt cleaner 37 collects the residual toner after the secondary transfer in the vicinity of the secondary transfer unit 34.

The waste toner recovery device 38 recovers the residual toner after the primary transfer collected by the waste toner collecting mechanism 36 and the residual toner after the secondary transfer collected by the intermediate transfer belt cleaner 37.

The sheet feeding mechanism 42 extracts sheets from the sheet cassette 41 in response to the image forming operations in the respective image forming stations 32a to 32d. The separation mechanism 43 separates the sheets extracted by the sheet feeding mechanism 42 one by one. The conveyance mechanism 44 conveys the sheets separated by the separation mechanism 43 one by one to the aligning mechanism 45. The aligning mechanism 45 conveys the sheets to the transfer position in accordance with timing of the image forming operations in the image forming stations 32a to 32d. Therefore, the sheets, which are extracted of the sheet cassette 41 by the sheet feeding mechanism 42 and separated one by one by the separation mechanism 43, pass through the conveyance mechanism 44 and the aligning mechanism 45 to move to the transfer position.

In a case where the MFP 1 forms an image on a sheet, the fixing unit 35 heats and pressures the sheet and the discolorable toner image attached to the sheet in an electrostatic manner at the fixing temperature, and fixes the discolorable toner image to the sheet. Specifically, the discolorable toner which is transferred to the sheet in the electrostatic manner by the secondary transfer unit 34 is heated and melted by the fixing unit 35 at the fixing temperature. The discolorable toner exhibits a predetermined color when the coloring compound develops a color by the action of the developing agent. The melted discolorable toner is kept in a state of exhibiting the predetermined color, and fused to the sheet by being pressed by the fixing unit 35. The discolorable toner is fused to the sheet, such that the discolorable toner image is fixed to the sheet.

The MFP 1 includes a discharging unit and a discharging roller (not illustrated). The discharging unit is disposed in a space between the image reading unit 5 and the image forming unit 3. The discharging unit holds the sheet discharged to the outside of the MFP 1. The discharging roller is disposed on the rear stage of the fixing unit 35. The discharging roller discharges the sheet, to which the discolorable toner image is fixed, to the discharging unit in cooperation with the fixing unit 35. In a case where images are formed on both faces of the sheet, the discharging roller reversely rotates, thereby sending the sheet discharged halfway to the discharge unit to the ADU 40.

The ADU 40 conveys the sheet delivered by the discharging roller to the aligning mechanism 45 again. The sheet is conveyed to the aligning mechanism 45 in the state in which the front and rear sides are reversed such that the discolorable toner image is transferred to a second face (for example, the rear face) which is the back face to a first face (for example, the front face) on which the discolorable toner image is fixed.

The ADU 40, as illustrated in FIG. 8, can be open or closed with respect to the side face of the main body of the MFP 1 by being supported to be rotatable in the direction of arrow A around a supporting point 40a as the center. In the closed state, the ADU 40, as illustrated in FIG. 7, substantially adheres to the side face of the main body of the MFP 1 so as to cover the supporting point 146a of the second tray mounting unit and the second manual feeding tray 146 mounted at the supporting point 146a. The ADU 40 can be used in the closed state. On the other hand, in the open state, as illustrated in FIG. 8, the ADU 40 is separated from the side face of the main body of the MFP 1 such that the supporting point 146a of the second tray mounting unit and the second manual feeding tray 146 mounted at the supporting point 146a are exposed. For example, when a jam of a sheet occurs in the MFP 1, in order to remove the sheet from the MFP 1, the user can open the ADU 40 with respect to the side face of the main body of the MFP 1.

In the state in which the ADU 40 is closed (when the ADU 40 is used), since the supporting point 146a of the second tray mounting unit is covered with the ADU 40, the user can neither mount the second tray 146 at the supporting point 146a nor separate the second tray 146 from the supporting point 146a. In addition, in the state in which the ADU 40 is closed, since the second manual feeding tray 146 mounted at the supporting point 146a is covered with the ADU 40, the user cannot open the second manual feeding tray 146. On the other hand, in the state in which the ADU 40 is open (when the ADU 40 is not used), since the supporting point 146a of the second tray mounting unit is exposed, the user can mount the second manual feeding tray 146 at the supporting point 146a or separate the second manual feeding tray 146 from the supporting point 146a. In addition, in the state in which the ADU 40 is open, since the second manual feeding tray 146 mounted at the supporting point 146a is exposed, the user can open the second manual feeding tray 146. In other words, the second manual feeding tray 146 cannot be used in the state in which the ADU 40 is closed and can be used in the state in which the ADU 40 is open.

The second manual feeding tray 146 does not need to be constantly mounted at the supporting point 146a of the second tray mounting unit. The user may mount the second manual feeding tray 146 at the supporting point 146a only when the image formed on a sheet is erased or the image is discolored. The second manual feeding tray 146 has the same structure as that of the manual feeding tray 46. Accordingly, as illustrated in FIG. 8, the user can separate the manual feeding tray 46 from the supporting point 46a in the direction of arrow B and mount the separated manual feeding tray 46 at the supporting point 146a of the second tray mounting unit in the direction of arrow C. By allowing the manual feeding tray 46 to be used as the second manual feeding tray 146, the cost of components of the MFP 1 can be reduced.

A control configuration of the MFP 1 will be described with reference to FIG. 9. FIG. 9 is a block diagram illustrating the control configuration of the MFP 1. As illustrated in FIG. 9, the control unit 7 includes the I/F 71 which serves as an image input unit, the image processing unit 73, and a modulation circuit 75 which serves as an exposure signal generating unit. The I/F 71 receives, for example, image data which is supplied from an external device such as a PC, or image data which is supplied via a network or the like. The image processing unit 73 performs the character identification, the contour correction, the color tone correction, and a predetermined image processing concerning the γ-characteristic as described above, on image signals generated by the image reading unit 5 or image data received from the I/F 71. The modulation circuit 75 converts the image data processed by the image processing unit 73 into a modulation signal (an exposure signal) for the laser light beam by the exposure unit 31.

The control unit 7 includes a central processing unit (CPU) 77 and a main processing unit (MPU) 79. The CPU 77 controls an image signal system such as the I/F 71, the image processing unit 73, and the modulation circuit 75. The MPU 79 is connected to the CPU 77 and controls the entire operations of the MFP 1 including the image forming unit 3 and the image reading unit 5. For example, the MPU 79 controls an image reading operation of the image reading unit 5 and the image forming operation of the image forming unit 3. Further, the MPU 79 controls the heating temperature of the fixing unit 35 at the time of the image forming operation and the heating temperature of the fixing unit 35 at the time of an image erasing operation and an image decoloring operation to be described later. The heating temperature of the fixing unit 35, as will be described later, is controlled by the MPU 79 to be changed from the fixing temperature to the erasing temperature when the image erasing operation is performed. The heating temperature of the fixing unit 35 is controlled by the MPU 79 so as to be changed from the fixing temperature to the discoloring temperature when the image discoloring operation is performed. The heating temperature of the fixing unit 35 is controlled by the MPU 79 so as to be changed from the erasing temperature or the discoloring temperature to the fixing temperature at the time of the image forming operation.

The MPU 79 controls each unit of the MFP 1 in accordance with a control input from the operation panel 9 that receives a user's instruction for the MFP 1. The operation panel 9 includes a plurality of keys and a display panel 9a.

The plurality of keys of the operation panel 9 include a start key that receives a user's start instruction for an operation such as an image forming operation, an image erasing operation, or an image discoloring operation.

The display panel 9a displays the state of each unit of the MFP 1, for example, a standby time for changing the heating temperature of the fixing unit 35 at the time of performing the image erasing operation, the image discoloring operation, and the image forming operation and the like by using a user interface that is widely known as a character string, a pictogram/icon, and the like. The display panel 9a displays the reception of a control input from the user and the content of the received input. The display panel 9a displays various contents described above under the control of the MPU 79. The MPU 79 is connected to an I/F (Interface) 72 for inputting/outputting information from/to the operation panel 9.

The control unit 7 includes a ROM (Read Only Memory) 111 storing a program, a RAM (Random Access Memory) 113, a NVM (Non-volatile Memory) 115, a page memory 117 and I/O port (Input/Output Port) 119. The page memory 117 is a work memory that provides a work area for the image processing performed by the image processing unit 73. The MPU 79 is connected to the ROM 111, the RAM 113, and the I/O port 119. The I/O port 119 inputs the output of a sensor 120 to the MPU 79. The sensor 120 includes an ADU sensor that detects the opening/closing of the ADU 40 and a tray sensor that detects a usable state of any one of the manual feeding tray 46 and the second manual feeding tray 146. The usable state of any one of the manual feeding tray 46 and the second manual feeding tray 146 is a state indicating whether the manual feeding tray 46 or the second manual feeding tray 146 is attached to either the supporting point 46a or the supporting point 146a.

In addition, the sensor 120, for example, includes a temperature sensor that detects the heating temperature of the fixing unit 35, a sheet sensor that detects the presence/absence of a sheet in the manual feeding trays 46 and 146, a discharge sensor that detects the passage of a sheet through the fixing unit 35, and the like.

The MPU 79 is connected to a motor driver 121 that controls the rotation of arbitrary motors 131, 133, 139, and the like. The motor 131, for example, drives the image forming stations 32a to 32d, the intermediate transfer belt 33, and the like.

The motor 133 drives sheet conveying units from the cassette to the fixing unit 35 and the ADU 40, for example, the sheet feeding mechanism 42, the separation mechanism 43, the conveyance mechanism 44, the aligning mechanism 45, and the secondary transfer unit 34.

In addition, the motor 133 drives sheet conveying units from the manual feeding tray 46 to the fixing unit 35, for example, the sheet feeding mechanism 47, the separation mechanism 48, and the timing matching mechanism 49.

Furthermore, the motor 133 drives sheet conveying units from the second manual feeding tray 146 to the fixing unit 35, for example, the sheet feeding mechanism 147, the separation mechanism 148, the second timing matching mechanism 149, and the like.

The motor 139 drives the fixing unit 35 independently from the conveyance units 42 to 45, 47 to 49, and 147 to 149.

The motor 133 drives either the conveyance units 47 to 49 or the conveyance units 147 to 149 and stops the driving of the other conveyance units in accordance with the output (detection result) of the tray sensor of the sensor 20.

The conveyance units 47 to 49 and the conveyance units 147 to 149 may be driven by motors that are independent from each other.

The MPU 79 is connected to a heater driving device 123 that drives a heater 35a for changing the heating temperature of the fixing unit 35.

As will be described later, by changing the heating temperature using the heater 35a, the fixing unit 35 operates for fixing an image formed on a sheet, erasing the image, and discoloring the image.

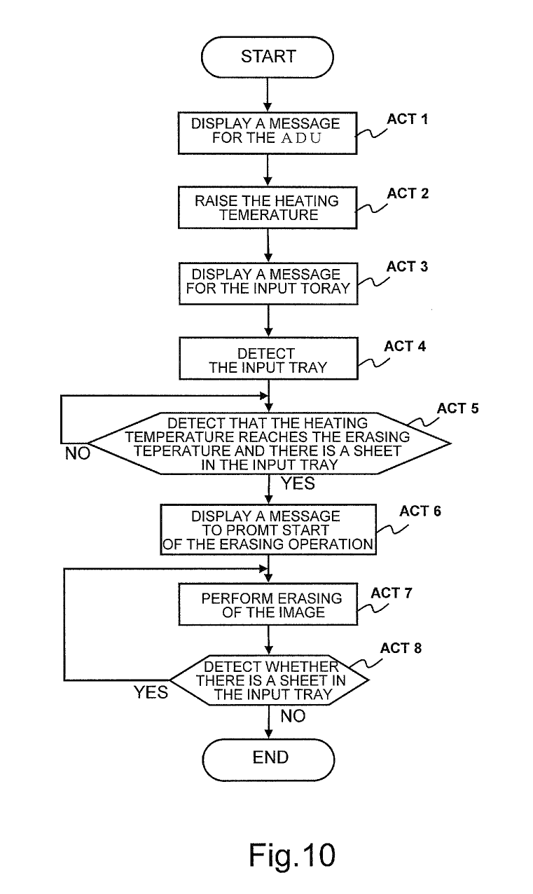

The image erasing operation performed by the fixing unit 35 will be described with reference to FIG. 10. FIG. 10 is a flowchart illustrating the image erasing operation of the MFP 1.

The discolorable toner used for the image (toner image) of a sheet, as described above, is decolored by being heated to the erasing temperature. More specifically, the discolorable toner is decolored as the action of the developing agent for the coloring compound is stopped so as to resolve the color developed state. As the discolorable toner is decolored, the image of the sheet is erased. The discolorable toner used for the image of the sheet is discolored from the original color, for example, to a transparent color by being heated to the discoloring temperature. As the discolorable toner is discolored, the image of the sheet is discolored.

The fixing unit 35 includes a roller in which the heater 35a is built. The heater 35a, for example, is a heater lamp. The fixing unit 35 may be configured to include an induction heating coil (IH) heater, which causes induced heat on the metal face of the roller, as the heater 35a. The fixing unit 35 may be configured to include a belt instead of the roller and the IH heater, which causes induced heat on the metal layer of the belt, as the heater 35a. The fixing unit 35 heats the image of a sheet using the heater 35a. The fixing unit 35 can change the heating temperature according to the heater 35a to the fixing temperature, the discoloring temperature that is higher than the fixing temperature, and the erasing temperature.

In a case where the heating temperature of the fixing unit 35 is the fixing temperature, as described above, the fixing unit 35 fixes the image of the sheet. On the other hand, in a case where the heating temperature of the fixing unit 35 is the erasing temperature, the fixing unit 35 decolors the toner by heating the image of the sheet to the erasing temperature, thereby erasing the image of the sheet. In a case where the heating temperature of the fixing unit is the discoloring temperature, the fixing unit 35 discolors the toner, for example, to have a transparent color by heating the image of the sheet to the discoloring temperature, thereby discoloring the image of the sheet.

The MFP 1 can erase the image of the sheet and discolor the image by the fixing unit 35 without arranging independent units for erasing the image and discoloring the image.

In a case where the MFP 1 performs the operation of erasing the image of a sheet, as illustrated in FIG. 10, in ACT 1, the operation panel 9 receives selection of the image erasing operation from the user, and the control unit displays a message such as “Please open ADU” on the display panel 9a based on the user's selection of the image erasing operation from the operation panel 9.

In ACT 2, the control unit 7 instructs the heater driving device 123 to control the heater 35a. In order to raise the heating temperature of the fixing unit 35 to the erasing temperature, the heater driving device 123 starts temperature control of the heater 35a in accordance with the instruction from the control unit 7.

In ACT 3, the control unit 7 determines whether or not the ADU 40 is open based on the detection result by the ADU sensor that is input to the control unit 7 through the I/O port 119. As illustrated in FIG. 8, when the control unit 7 determines that the ADU 40 is open, the control unit 7 displays a message such as “Please mount manual feeding tray inside ADU” for urging the user to prepare the image erasing operation on the display panel 9a.

In ACT 4, the control unit 7 determines whether the manual feeding tray 46 or the second manual feeding tray 146 is mounted at the supporting point 146a based on of the detection result by the tray sensor that is input through the I/O port 119. Hereinafter, the manual feeding tray 46 is assumed to be mounted at the supporting point 146a in the description. As illustrated in FIG. 8, when the control unit 7 determines that the manual feeding tray 46 is mounted at the rotation supporting point 146a, the operation of the MFP 1 proceeds to ACT 5.

In ACT 5, the control unit 7 determines whether or not the heating temperature of the fixing unit 35 reaches the erasing temperature based on the detection result by the temperature sensor that is input through the I/O port 119.

In addition, in ACT 5 described above, the control unit 7 determines whether or not a sheet is present in the manual feeding tray 46 mounted at the supporting point 146a based on the detection result by the sheet sensor that is input through the I/O port 119. When it is determined that a sheet is not present in the manual feeding tray 46, the control unit 7 displays a message such as “Please place sheet in manual feeding tray” for urging the user to prepare the image erasing operation on the display panel 9a.

When the control unit 7 determines that the heating temperature of the fixing unit 35 reaches the erasing temperature, and a sheet is present in the manual feeding tray 46 (Yes in ACT 5), the operation of the MFP 1 proceeds to ACT 6.

In ACT 6, the control unit 7 displays a message such as “Please turn on start key” urging the user to start the image erasing operation on the display panel 9a.

In ACT 6 described above, when the control unit 7 determines that the operation panel 9 receives the turning on of the start key, the operation of the MFP 1 proceeds to ACT 7.

In ACT 7, the control unit 7 instructs the motor driver 121 to control the driving of the motors 133 and 139. The motor driver 121 controls the motor 133 so as to drive the conveyance units 147 to 149. The motor 133 drives the conveyance units 147 to 149. The conveyance units 147 to 149 convey a sheet from the manual feeding tray 46 mounted at the supporting point 146a to the fixing unit 35. The motor driver 121 controls the motor 139 so as to drive the fixing unit 35. The motor 139 drives the fixing unit 35. The fixing unit 35 erases the image of the sheet while conveying the sheet.

In ACT 7 described above, the control unit 7 determines whether or not the sheet has passed through the fixing unit 35, in other words, whether or not erasing of the image of one sheet has been completed based on the detection result by the discharge sensor that is input through the I/O port 119. When the control unit 7 determines that the erasing of the image of one sheet has been completed, the operation of the MFP 1 proceeds to ACT 8.

In ACT 8, the control unit 7 determines whether or not a sheet is present in the manual feeding tray 46 mounted at the supporting point 146a based on the detection result by the sheet sensor that is input through the I/O port 119. In a case where the control unit 7 determines that a sheet is present in the manual feeding tray 46 (Yes in ACT 8), the operation of the MFP 1 is returned to ACT 7. On the other hand, in a case where the control unit 7 determines that a sheet is not present in the manual feeding tray 46 (No in ACT 8), the image erasing operation of the MFP 1 ends, and the MFP 1 is in the standby state.

During the image erasing operation performed in ACT 7, the ADU 40 is in the open state, and the motor driver 121 controls the motors 133 and 139 such that only the fixing unit 35 and the conveyance units 147 to 149 are driven. Accordingly, the power consumed by the motor 131 and the like driving the image forming stations 32a to 32d is not necessary, whereby the power consumption of the MFP 1 can be reduced.

In a case where the MFP 1 performs the operation of discoloring the image of the sheet, in the operation control illustrated in FIG. 10, the control unit 7 controls the heating temperature of the fixing unit 35 to be the discoloring temperature instead of the erasing temperature.

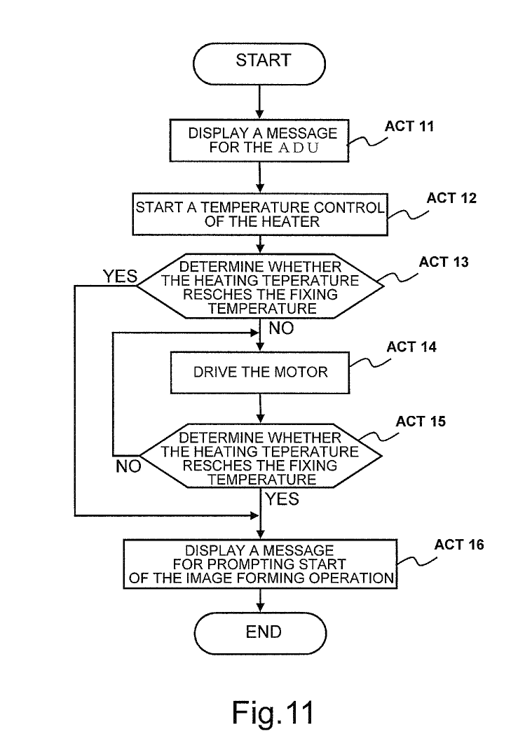

The operation of the MFP 1 for returning from the image erasing operation to the image forming operation will be described with reference to FIG. 11. FIG. 11 is a flowchart illustrating the operation of returning from the image erasing operation to the image forming operation in the MFP 1.

In the image erasing operation illustrated in FIG. 10, in order to erase the image of a sheet, the heating temperature of the fixing unit 35 is changed to the erasing temperature that is higher than the fixing temperature. Accordingly, in a case where the image forming operation is directed by the user, temperature control is necessary for lowering the heating temperature of the fixing unit 35 from the erasing temperature to the fixing temperature.

As illustrated in FIG. 11, in ACT 11, when the operation panel 9 receives termination of the image erasing operation, such as the user's selection of the image forming operation, the control unit 7 displays a message such as “Please separate manual feeding tray from ADU and close ADU” on the display panel 9a of the operation panel 9 based on the user's selection of the image forming operation from the operation panel 9.

In ACT 12, the control unit 7 instructs the heater driving device 123 to control the heater 35a. The heater driving device 123 starts control of the temperature of the heater 35a so as to lower the heating temperature of the fixing unit 35 to the fixing temperature in accordance with an instruction from the control unit 7.

In ACT 13, the control unit 7 determines whether or not the heating temperature of the fixing unit 35 reaches the fixing temperature based on the detection result by the temperature sensor that is input through the I/O port 119.

More specifically, for example, the control unit 7 predicts whether or not a time required for the heating temperature of the fixing unit 35 to reach the fixing temperature is longer than a predetermined time.

In ACT 13 described above, in a case where the control unit 7 predicts that the time required for the heating temperature of the fixing unit 35 to reach the fixing temperature is longer than the predetermined time (No in ACT 13 described above), the operation of the MFP 1 proceeds to ACT 14.

In ACT 14, the control unit 7 instructs the motor driver 121 to control driving of the motor 139. The motor driver 121 controls only the motor 139. The motor 139 drives the fixing unit 35 by operating for a predetermined time. By driving the fixing unit 35, a decrease in the heating temperature of the fixing unit 35 is promoted.

The case where the control unit 7 predicts that the time required for the heating temperature of the fixing unit 35 to reach the fixing temperature is longer than the predetermined time is a case where the heating temperature of the fixing unit 35 is higher than the fixing temperature, and, for example, a difference between the heating temperature and the fixing temperature is 10% of the fixing temperature or more.

In ACT 15, after the driving of the fixing unit 35 for the predetermined time, the control unit 7 determines whether or not the heating temperature of the fixing unit 35 reaches the fixing temperature based on the detection result by the temperature sensor that is input through the I/O port 119 again.

More specifically, as described above, the control unit 7 predicts whether or not the time required for the heating temperature of the fixing unit 35 to reach the fixing temperature is longer than the predetermined time.

In ACT 15 described above, in a case where the control unit 7 predicts that the time required for the heating temperature of the fixing unit 35 to reach the fixing temperature is longer than the predetermined time (No in ACT 15), the process of the MFP 1 is returned to ACT described above. In ACT 14 described above, as described above, the motor driver 121 controls only the motor 139. The motor 139 drives the fixing unit 35.

In ACT 13 described above, in a case where the control unit 7 predicts that the time required for the heating temperature of the fixing unit 35 to reach the fixing temperature is within the predetermined time (Yes in ACT 13), the process of the MFP 1 proceeds to ACT 16. In addition, in ACT 15 described above, in a case where the control unit 7 predicts that the time required for the heating temperature of the fixing unit 35 to reach the fixing temperature is within the predetermined time (Yes in ACT 15), the process of the MFP 1 proceeds to ACT 16.

The case where the control unit 7 predicts that the time required for the heating temperature of the fixing unit 35 to reach the fixing temperature is within the time is a case where the heating temperature of the fixing unit 35 is higher than the fixing temperature, and, for example, a difference between the heating temperature and the fixing temperature is less than 10% of the fixing temperature.

In ACT 16, the control unit 7 displays a message such as “Copy can be performed” for urging the user to perform an image forming operation on the display panel 9a of the operation panel 9. Until the temperature of the fixing unit 35 is actually and completely the fixing temperature after the message urging the user to perform the image forming operation is displayed, a slight time lag may occur. However, the time lag is not of the degree for which the user recognizes undesired standby time. For example, in consideration of the occurrence of the time lag, the display panel 9a may display a message such as “Please wait for about 10 seconds”.

While an example of the operation for returning the heating temperature of the fixing unit 35 from the erasing temperature to the fixing temperature has been described with reference to FIG. 11, also in a case where the heating temperature of the fixing unit 35 is returned from the discoloring temperature to the fixing temperature, the MFP 1 performs the same returning operation as that illustrated in FIG. 11.

In the MFP 1 according to the first embodiment illustrated in FIG. 1, a control in a case where the insufficiency in the residual amount of one or more coloring materials is detected will be described.

The residual amount detection unit 30 illustrated in FIG. 9 detects the residual amount of the discolorable toner 51a of the color BK used in the image forming station 32a, the residual amount of the discolorable toner 51b of the color C used in the image forming station 32b, the residual amount of the discolorable toner 51c of the color M used in the image forming station 32c, and the residual amount of the discolorable toner 51d of the color Y used in the image forming station 32d. For example, the residual amount detection unit 30 detects: that the residual amount of the toner 51a of the color BK of the image forming station 32a is less than a predetermined value; that the residual amount of the toner 51b of the color C of the image forming station 32b is less than the predetermined value; that the residual amount of the toner 51c of the color M of the image forming station 32c is less than the predetermined value; and that the residual amount of the toner 51d of the color Y of the image forming station 32d is less than the predetermined value. In other words, the residual amount detection unit 30 detects the insufficiency in the residual amounts of the discolorable toners of the respective colors in the image forming stations 32a to 32d.

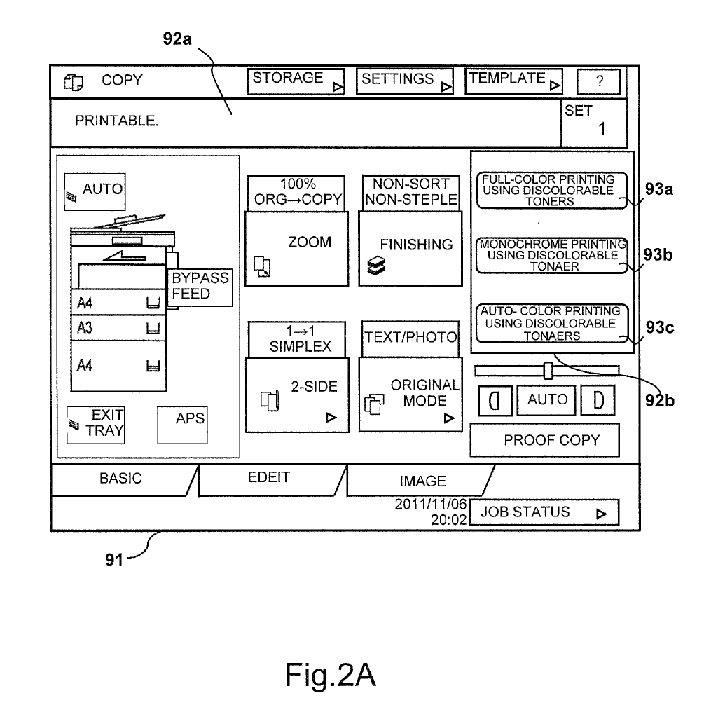

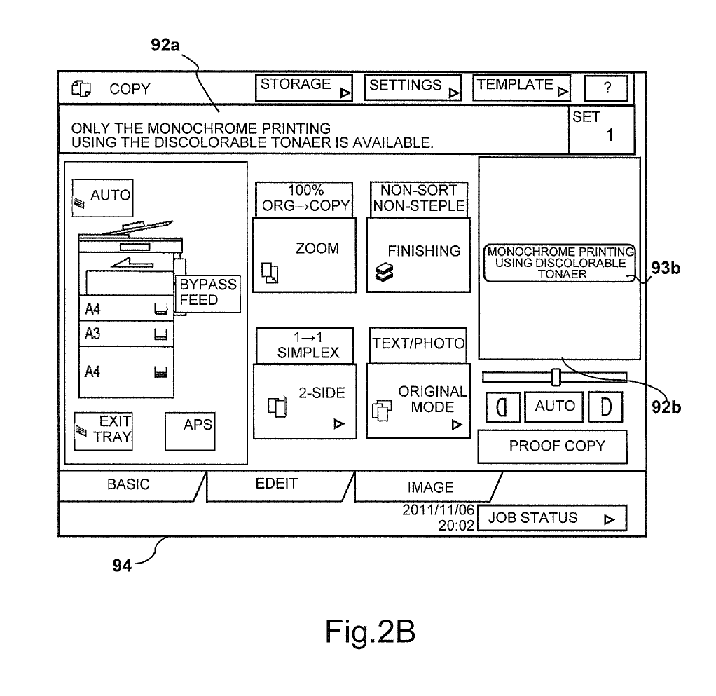

For example, in a case where the residual amount detection unit 30 detects that the residual amounts of the respective discolorable toners 51a to 51d of the color BK, C, M, and Y are equal to or larger than the predetermined value, the MPU 79 of the control unit 7 controls the screen display of the display unit 9a as illustrated in FIG. 2A. The display unit 9a displays a first screen 91 illustrated in FIG. 2A.

The first screen 91 includes a message display area 92a and a select button display area 92b. In FIG. 2A, the display unit 9a displays the state of the MFP 1 in the message display area 92a. Specifically, the display unit 9a displays, for example, a message “Printable” in the message display area 92a. The display unit 9a displays in the select button display area 92b select buttons of image forming modes which are executable by the MFP 1, in other words, print modes which are selectable by the user. Specifically, the display unit 9a displays select buttons 93a, 93b, and 93c in the select button display area 92b. The select button 93a receives a user's selection of a full-color printing using the discolorable toners of four colors. The select button 93b receives a user's selection of a monochrome printing using the discolorable toner of one color. The select button 93c receives a user's selection of an automatic color printing using the discolorable toners of four colors.

In other words, the first screen 91 is a screen through which the user can select any one of the full-color printing using the discolorable toners, the automatic color printing using the discolorable toners, and the monochrome printing using the discolorable toner. For example, the user operates the select button 93a to select the full-color printing. Further, when the user operates the start key of the operation panel 9, the MPU 79 controls a full-color image formation, using the discolorable toners of four colors, based on the image data. The image forming unit 3 is controlled by the MPU 79 to perform the full-color image formation, using the discolorable toners of four colors, based on the image data. Specifically, the image forming stations 32a to 32d form a full-color image using the discolorable toners 51a to 51d based on the image data. The full-color image formed by the image forming stations 32a to 32d can be discolored by being heated by the fixing unit 35 at the discoloring temperature. Further, the full-color image formed by the image forming stations 32a to 32d can be erased by being heated by the fixing unit 35 at the erasing temperature.

For example, the user operates the select button 93b to select the monochrome printing. Further, when the user operates the start key of the operation panel 9, the MPU 79 controls a monochrome image formation, using the discolorable toner of one color, based on the image data. The image forming unit 3 is controlled by the MPU 79 to perform the monochrome image formation, using the discolorable toner of one color, based on the image data. Specifically, the image forming station 32a forms a monochrome image using the discolorable toner 51a based on the image data. The monochrome image formed by the image forming station 32a can be discolored by being heated by the fixing unit 35 at the discoloring temperature. Further, the monochrome image formed by the image forming station 32a can be erased by being heated by the fixing unit 35 at the erasing temperature.

For example, in a case where the residual amount detection unit 30 detects that the residual amount of at least one toner (for example, any toner other than the toner 51a of the color BK) from among the toners 51a to 51d of the color BK, C, M, and Y is less than the predetermined value, and in a case where the residual amount detection unit 30 detects that the residual amount of at least one toner (for example, the toner 51a of the color BK) from among the toners 51a to 51d of the color BK, C, M, and Y is equal to or larger the predetermined value, the MPU 79 controls the screen display of the display unit 9a as illustrated in FIG. 2B. The display unit 9a displays a second screen 94 illustrated in FIG. 2B instead of the first screen 91 of FIG. 2A.

Similarly to the first screen 91 of FIG. 2A, the second screen 94 includes the message display area 92a and the select button display area 92b. The display unit 9a displays in the message display area 90a, for example, a message “Only the monochrome printing using the discolorable toner is available”. The display unit 9a displays in the select button display area 90b only the select button 93b corresponding to the monochrome printing which is executable by the MFP 1 using the discolorable toner of one color.

In other words, the second screen 94 is a screen through which the user can select only the monochrome printing. In the second screen 94, the user is not allowed to select the full-color printing and the automatic color printing. For example, the user operates the select button 93b to select the monochrome printing. Further, when the user operates the start key of the operation panel 9, the MPU 79 controls the monochrome image formation, using the discolorable toner of one color, based on the image data. The image forming unit 3 is controlled by the MPU 79 to perform the monochrome image formation, using the discolorable toner of one color, based on the image data. Specifically, the first image forming station 32a forms a monochrome image using the discolorable toner 51a based on the image data. The monochrome image formed by the image forming station 32a can be discolored and erased as described above.

As described above, in the first embodiment, in a case where the insufficiency in the residual amount of one or more toners from among the plurality of discolorable toners 51a to 51d is detected, the MFP 1 forbids the full-color printing and the automatic color printing using the toner insufficient in the residual amount, and allows the printing using one or more toners not insufficient in the residual amount. For example, in a case where the insufficiency in the residual amount of the discolorable toner 51c of the color M is detected, the full-color printing and the automatic color printing are forbidden, and the monochrome printing using the toners 51a, 51b, and 51d other than the toner 51c of the color M is allowed. Therefore, even when the residual amount of one or more discolorable toners from among the plurality of discolorable toners 51a to 51d is insufficient, the MFP 1 can form an image using one or more discolorable toners not insufficient in the residual amount. Accordingly, it is possible to improve a decrease in processing efficiency.

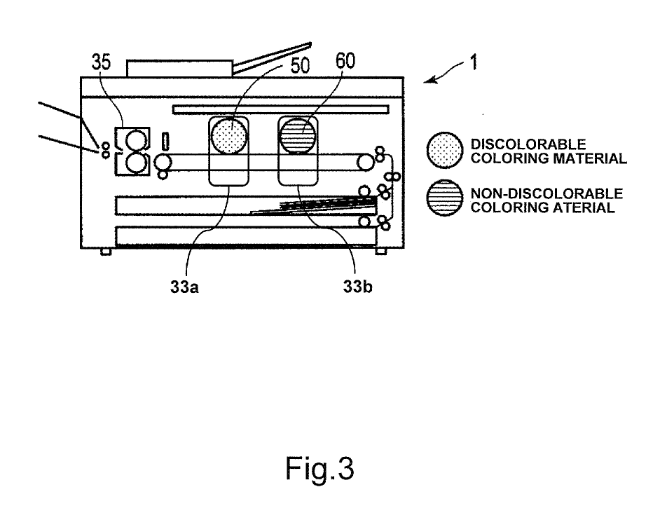

FIG. 3 is a cross-sectional view illustrating main parts of the MFP 1 according to a second embodiment. The MFP 1 according to the second embodiment illustrated in FIG. 3 includes a first image forming station 33a and a second image forming station 33b. The image forming stations 33a and 33b form images of the color BK. The image of the color BK formed by the image forming station 33a is formed using a toner or an ink which is a discolorable coloring material of the color BK under a predetermined condition. The image of the color BK formed by the image forming station 33b is formed using a toner or an ink which is a non-discolorable coloring material. In FIG. 3, a coloring material 50 is a discolorable toner of BK or a discolorable ink of the color BK. A coloring material 60 is a non-discolorable toner of the color BK or a non-discolorable ink of the color BK.

An example of the predetermined condition described above includes heat (temperature). The discolorable toner is decolored and discolored by being heated at a predetermined temperature higher even than the heating temperature (fixing temperature) of the fixing unit 35 at the time of the fixing operation.

For example, the color of the discolorable toner is changed, different from the original color, by being heated at a predetermined discoloring temperature higher even than the fixing temperature. The different color is, for example, a transparent color. Therefore, the fixing unit 35 can make an image discolored by heating the image formed by using the discolorable toner at the discoloring temperature. Further, the discolorable toner is changed in color from the original color to a transparent color having a substantial 100% transparency by being heated at a predetermined erasing temperature higher even than the discoloring temperature. In other words, the discolorable toner is decolored by being heated at the erasing temperature. Therefore, the fixing unit 35 can make an image erased by heating the image formed by using the discolorable toner at the erasing temperature.

The discolorable ink is decolored and discolored at a lower heating temperature lower than that of the discolorable toner based on a composition of dyes included in the ink. Another example of the predetermined condition described above is light (an ultraviolet ray or the like). The discolorable ink is decolored and discolored based on the composition of dyes contained in the ink in accordance with the irradiation of the ultraviolet ray thereto or the like.

A specific example of a discolorable toner 50 used by the MFP 1 according to the second embodiment, and the principle of discolorization and decolorization of the discolorable toner 50 will be described.

When being heated to the discoloring temperature, the discolorable toner 50 starts to be discolored. When the discolorable toner 50 is heated further to a temperature equal to or higher than the erasing temperature, the color thereof becomes a transparent color having 100% transparency, whereby discolorable toner 50 is decolored. Specifically, the discolorable toner 50 contains a binder resin and a pigment. The binder resin is the same as well-known toner (the non-discolorable toner). The discolorable toner 50 has a feature in the pigment. The pigment includes a coloring compound, a developing agent, and a discoloring temperature regulating agent (a temperature control agent). The coloring compound is a coloring agent; for example, a leuko dye is used. An example of the developing agent includes phenols. When being heated, the discoloring temperature regulating agent is compatible with the coloring compound; a material having no affinity to the developing agent is used. The discolorable toner 50 exhibits a predetermined color when the coloring compound develops a color by interacting with the developing agent. When the discolorable toner 50 is heated to a temperature equal to or higher than the discoloring temperature, the interaction between the coloring compound and the developing agent is weakened to cause the discolorable toner to be discolored, for example, to be a transparent color. When the discolorable toner 50 is further heated to a temperature equal to or higher than the erasing temperature, the interaction between the coloring compound and the developing agent is disconnected to cause the discolorable toner to be decolored finally. The discoloring temperature and the erasing temperature can be adjusted by appropriately combining the discoloring temperature regulating agent therewith.

Differences between the MFP 1 according to the first embodiment illustrated in FIG. 1 and the MFP 1 according to the second embodiment illustrated in FIG. 3 are as illustrated in FIGS. 1 and 3. The MFP 1 according to the first embodiment illustrated in FIG. 1 includes the first to fourth image forming stations 32a to 32d. On the contrary, the MFP 1 according to the second embodiment includes the first and second image forming stations 33a and 33b as described above. The image forming station 33a forms an image using the toner 50 which is the discolorable coloring material of the color BK. The image forming station 33b forms an image using the toner 60 which is the non-discolorable coloring material of the color BK.

The detailed description of the MFP 1 according to the first embodiment illustrated in FIG. 1 has been made with reference to FIGS. 7 to 9, but the MFP 1 according to the second embodiment illustrated in FIG. 3 is substantially equal to the MFP 1 according to the first embodiment except the differences described above. Therefore, the detailed description of the MFP 1 according to the second embodiment will not be presented.

As described above, the MFP 1 of FIGS. 7 to 9 is configured to refill the discolorable toners 51a to 51d used in the respective image forming stations 32a to 32d, for example, by replacing the housing units which house the discolorable toners 51a to 51d. Associating the MFP 1 of FIGS. 7 to 9 with the MFP 1 according to the second embodiment illustrated in FIG. 3, the MFP 1 of FIGS. 7 to 9 includes a first image forming station 33a and a second image forming station 33b instead of the image forming stations 32a to 32d. Further, the MFP 1 is configured to refill the discolorable toner 50 and a non-discolorable toner 60 which are used in the first image forming station 33a and the second image forming station 33b, for example, by replacing the housing units which house the discolorable toner 50 and the non-discolorable toner 60.

In the MFP 1 according to the second embodiment illustrated in FIG. 3, a control in a case where the insufficiency in the residual amount of one or more toners is detected will be described.

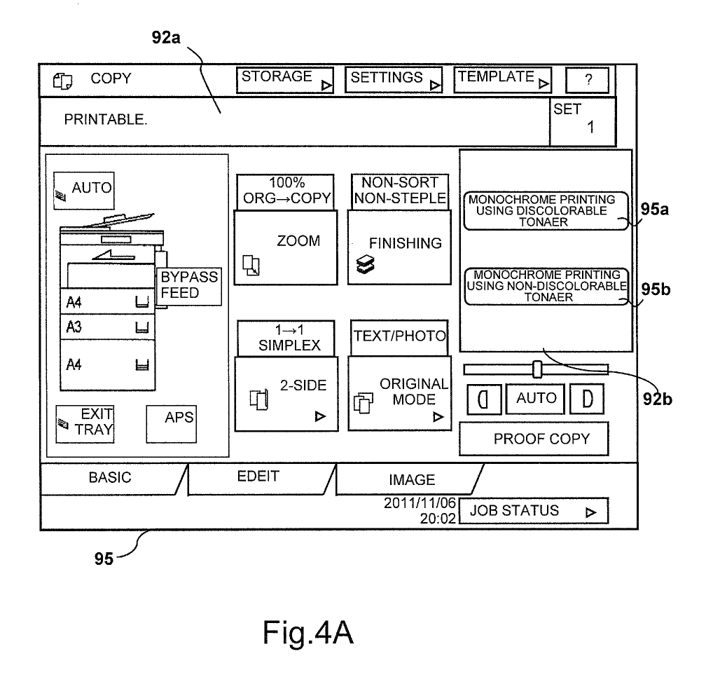

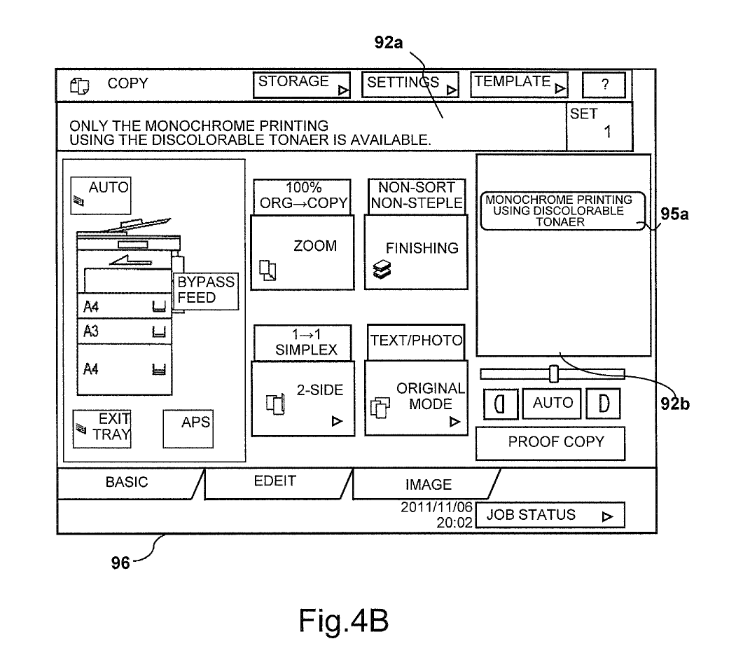

For example, in a case where the residual amount detection unit 30 detects that the residual amounts of the discolorable toner 50 of BK and the non-discolorable toner of the color BK are equal to or larger than the predetermined value, the MPU 79 controls the screen display of the display unit 9a as illustrated in FIG. 4A. The display unit 9a displays a first screen 95 as illustrated in FIG. 4A.

Similarly to the first screen 91 of FIG. 2A, the first screen 95 includes the message display area 92a and the select button display area 92b. The display unit 9a displays, for example, a message “Printable” in the message display area 92a. The display unit 9a displays select buttons 95a and 95b in the select button display area 92b. The select button 95a receives a user's selection of the monochrome printing using the discolorable toner. The select button 95b receives a user's selection of the monochrome printing using the non-discolorable toner.

In other words, the first screen 95 is a screen through which the user can select any one of the monochrome printing using discolorable toner and the monochrome printing using the non-discolorable toner. For example, the user operates the select button 95a to select the monochrome printing using the discolorable toner. Further, when the user operates the start key of the operation panel 9, the MPU 79 controls the monochrome image formation, using the discolorable toner, based on the image data. The image forming unit 3 is controlled by the MPU 79 to perform the monochrome image formation, using the discolorable toner, based on the image data. Specifically, the image forming station 33a of the image forming unit 3 forms a monochrome image using the discolorable toner 50 based on the image data. The monochrome image formed by the image forming station 33a can be discolored, for example, to be a transparent color by being heated by the fixing unit 35 at the discoloring temperature. Further, the monochrome image formed by the image forming station 33a can be erased, for example, by being heated by the fixing unit 35 at the erasing temperature.

For example, the user operates the select button 95b to select the monochrome printing using the non-discolorable toner. Further, when the user operates the start key of the operation panel 9, the MPU 79 controls the monochrome image formation, using the non-discolorable toner, based on the image data. The image forming unit 3 is controlled by the MPU 79 to perform the monochrome image formation, using the non-discolorable toner, based on the image data. Specifically, the second image forming station 33b forms a monochrome image using the non-discolorable toner 60 based on the image data.

For example, in a case where the residual amount detection unit 30 detects that the residual amount of the non-discolorable toner 60 of the color BK in the discolorable toner 50 of the color BK and the non-discolorable toner 60 of the color BK is less than the predetermined value, and in a case where the residual amount detection unit 30 detects that the residual amount of the discolorable toner 50 of the color BK is equal to or larger than the predetermined value, the MPU 79 controls the screen display of the display unit 9a as illustrated in FIG. 4B. The display unit 9a displays a second screen 96 illustrated in FIG. 4B instead of the first screen 95 of FIG. 4A.

Similarly to the first screen 91 of FIG. 2A, the second screen 96 includes the message display area 92a and the select button display area 92b. The display unit 9a displays in the message display area 92a, for example, a message “Only the monochrome printing using the discolorable toner is available”. The display unit 9a displays in the select button display area 92b only the select button 95a corresponding to the executable monochrome printing using the discolorable toner.

In other words, the second screen 96 is a screen through which the user can select only the monochrome printing using the discolorable toner. In the second screen 96, the user is not allowed to select the monochrome printing using the non-discolorable toner. For example, the user operates the select button 95a to select the monochrome printing using the discolorable toner. Further, when the user operates the start key of the operation panel 9, the MPU 79 controls the monochrome image formation, using the discolorable toner, based on the image data. The image forming unit 3 is controlled by the MPU 79 to perform the monochrome image formation, using the discolorable toner, based on the image data. Specifically, the first image forming station 33a forms a monochrome image using the discolorable toner 50 of BK based on the image data. The monochrome image formed by the image forming station 33a can be discolored and erased by being heated by the fixing unit 35 as described above.

For example, in a case where the residual amount detection unit 30 detects that the residual amount of the discolorable toner 50 of the color BK in the discolorable toner 50 of the color BK and the non-discolorable toner 60 of the color BK is less than the predetermined value, and in a case where the residual amount detection unit 30 detects that the residual amount of the non-discolorable toner 60 of the color BK is equal to or larger than the predetermined value, the MPU 79 controls the screen display of the display unit 9a. The display unit 9a displays in the second screen 96 a message content and a select button, which are different from those in the second screen 96 illustrated in FIG. 4B.

Specifically, the display unit 9a displays in the message display area 92a of the second screen 96, for example, a message “Only the monochrome printing using the non-discolorable toner is available”. The display unit 9a displays in the select button display area 92b only the select button 95b corresponding to the executable monochrome printing using the non-discolorable toner.

In other words, the second screen 96 is changed in its displaying content to be a screen through which the user can select only the monochrome printing using the non-discolorable toner. In the second screen 96, the user is not allowed to select the monochrome printing using the discolorable coloring material. For example, the user operates the select button 95b to select the monochrome printing using the non-discolorable toner. Further, when the user operates the start key of the operation panel 9, the MPU 79 controls the monochrome image formation using the non-discolorable toner. The image forming unit 3 is controlled by the MPU 79 to perform the monochrome image formation, using the non-discolorable toner, based on the image data. Specifically, the second image forming station 33b forms a monochrome image using the non-discolorable toner 60 of the color BK based on the image data.

As described above, in the second embodiment, in a case where the residual amount detection unit detects that the residual amount of the non-discolorable toner 60 in the discolorable toner 50 and the non-discolorable toner 60 is insufficient, the MFP 1 forbids the monochrome printing using the non-discolorable toner 60, and allows the monochrome printing using the discolorable toner 50 not insufficient in the residual amount. In a case where the insufficiency in the residual amount of the discolorable toner 50 in the discolorable toner 50 and the non-discolorable toner 60 is detected, the MFP 1 forbids the monochrome printing using the discolorable toner 50 is used, and allows the monochrome printing using the non-discolorable toner 60 not insufficient in the residual amount. Therefore, the MFP 1 can form an image using the toner not insufficient in the residual amount even when the residual amount of any one of the discolorable toner 50 and the non-discolorable toner 60 is insufficient. Accordingly, it is possible to improve a decrease in processing efficiency.

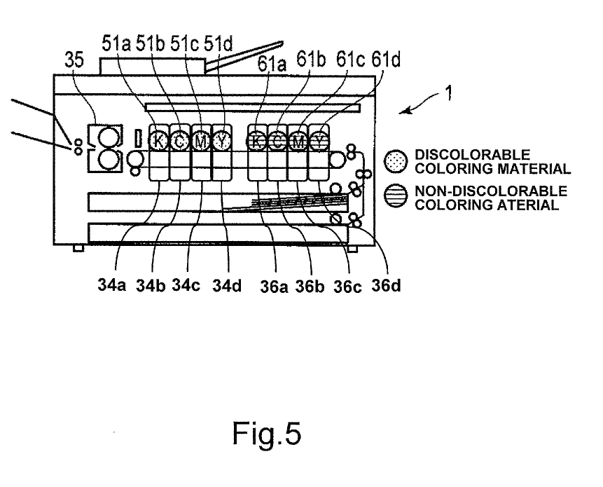

FIG. 5 is a cross-sectional view illustrating main parts of the MFP 1 according to a third embodiment. The MFP 1 according to the third embodiment illustrated in FIG. 5 includes first to eighth image forming stations 34a, 34b, 34c, 34d, 36a, 36b, 36c, and 36d. The first image forming station 34a forms, for example, an image using the discolorable coloring material of the color BK. The second image forming station 34b forms, for example, an image using the discolorable coloring material of the color C. The third image forming station 34c forms, for example, an image using the discolorable coloring material of the color M. The fourth image forming station 34d forms, for example, an image using the discolorable coloring material of the color Y. The fifth image forming station 36a forms, for example, an image using the non-discolorable coloring material of the color BK. The sixth image forming station 36b forms, for example, an image using the non-discolorable coloring material of the color C. The seventh image forming station 36c forms, for example, an image using the non-discolorable coloring material of the color M. The eighth image forming station 36d forms, for example, an image using the non-discolorable coloring material of the color Y. The discolorable coloring materials of the respective colors can be decolored and discolored under a predetermined condition. The non-discolorable coloring materials of the respective colors cannot be decolored and discolored even under the predetermined condition.

In FIG. 5, the coloring material 51a is the discolorable toner or the discolorable ink of the color BK. The coloring material 51b is the discolorable toner or the discolorable ink of the color C. The coloring material 51c is the discolorable toner or the discolorable ink of the color M. The coloring material 51d is the discolorable toner or the discolorable ink of the color Y. The coloring material 61a is the non-discolorable toner or the non-discolorable ink of the color BK. The coloring material 61b is the non-discolorable toner or the non-discolorable ink of the color C. The coloring material 61c is the non-discolorable toner or the non-discolorable ink of the color M. The coloring material 61d is the non-discolorable toner or the non-discolorable ink of the color Y.

An example of the predetermined condition described above includes heat (temperature). The discolorable toner is decolored and discolored by being heated at a predetermined temperature higher even than the heating temperature (the fixing temperature) of the fixing unit 35 at the time of the fixing operation.

For example, the colors of the discolorable toners 51a to 51d are changed, different from the original color, by being heated at a predetermined discoloring temperature higher even than the fixing temperature. The different color is, for example, a transparent color. Therefore, the fixing unit 35 can make an image discolored by heating the image formed by using the discolorable toner at the discoloring temperature. Further, the discolorable toners 51a to 51d are changed in color from the original color to a transparent color having a substantial 100% transparency by being heated at a predetermined erasing temperature higher even than the discoloring temperature. In other words, the discolorable toners 51a to 51d are decolored by being heated at the erasing temperature. Therefore, the fixing unit 35 can erase the images by heating the images formed by using the discolorable toners 51a to 51d at the erasing temperature.

Specifically, the discolorable toners 51a to 51d are the same as those used in the MFP 1 according to the first embodiment.

The discolorable ink is decolored and discolored even at a heating temperature lower even than the case of the discolorable toner depending on a composition of dyes included in the ink. Another example of the predetermined condition described above is light (an ultraviolet ray or the like). The discolorable ink is decolored and discolored based on the composition of dyes contained in the ink in accordance with the irradiation of ultraviolet ray thereto or the like.

Differences between the MFP 1 according to the first embodiment illustrated in FIG. 1 and the MFP 1 according to the third embodiment illustrated in FIG. 5 are as illustrated in FIGS. 1 and 5. The MFP 1 according to the first embodiment illustrated in FIG. 1 includes the first to fourth image forming stations 32a to 32d. On the contrary, the MFP 1 illustrated in FIG. 5 includes the first to eighth image forming stations 34a to 34d, and 36a to 36d. The first to fourth image forming stations 34a to 34d form images using the toners 51a to 51d which are the discolorable coloring materials of BK, C, M, and Y. The fifth to eighth image forming stations 36a to 36d form images using the toners 61a to 61d which are the non-discolorable coloring materials of the color BK, C, M, and Y.

As described above, the detailed description of the MFP 1 according to the first embodiment illustrated in FIG. 1 has been made with reference to FIGS. 7 to 9, but the MFP 1 according to the third embodiment illustrated in FIG. 5 is substantially equal to the MFP 1 according to the first embodiment except the differences described above. Therefore, the detailed description of the MFP 1 according to the third embodiment will not be presented.

As described above, the MFP 1 of FIGS. 7 to 9 is configured to refill the discolorable toners 51a to 51d used in the respective image forming stations 32a to 32d, for example, by replacing the housing units which house the discolorable toners 51a to 51d. Associating the MFP 1 of FIGS. 7 to 9 with the MFP 1 according to the third embodiment illustrated in FIG. 5, the MFP 1 of FIGS. 7 to 9 includes the image forming stations 34a to 34d, and 36a to 36d instead of the image forming stations 32a to 32d. Further, the MFP 1 is configured to refill the discolorable toners 51a to 51d and the non-discolorable toners 61a to 61d which are used in the image forming stations 34a to 34d, and 36a to 36d, for example, by replacing the housing units which house the discolorable toners 51a to 51d and the non-discolorable toners 61a to 61d.

In the MFP 1 according to the third embodiment illustrated in FIG. 5, a control in a case where the insufficiency in the residual amount of one or more toners is detected will be described.

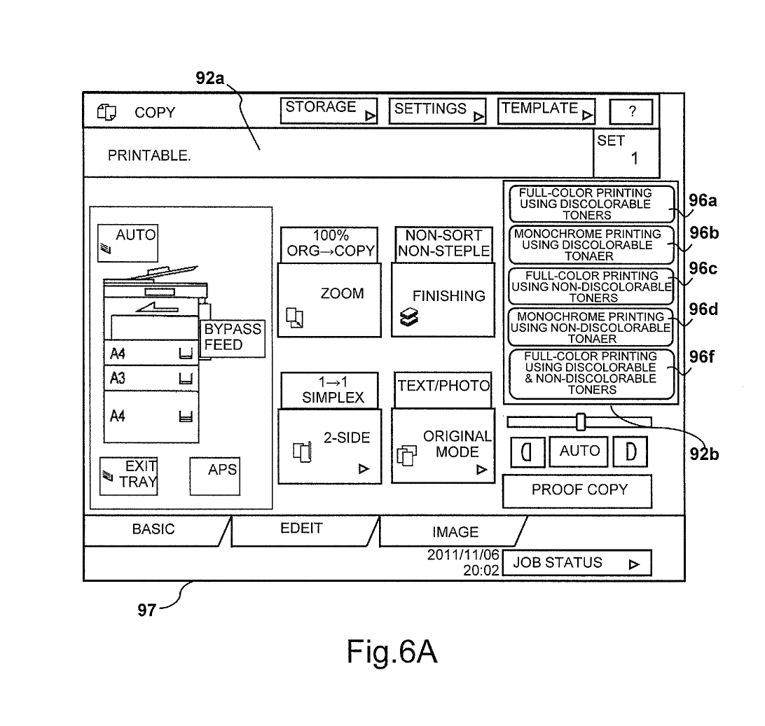

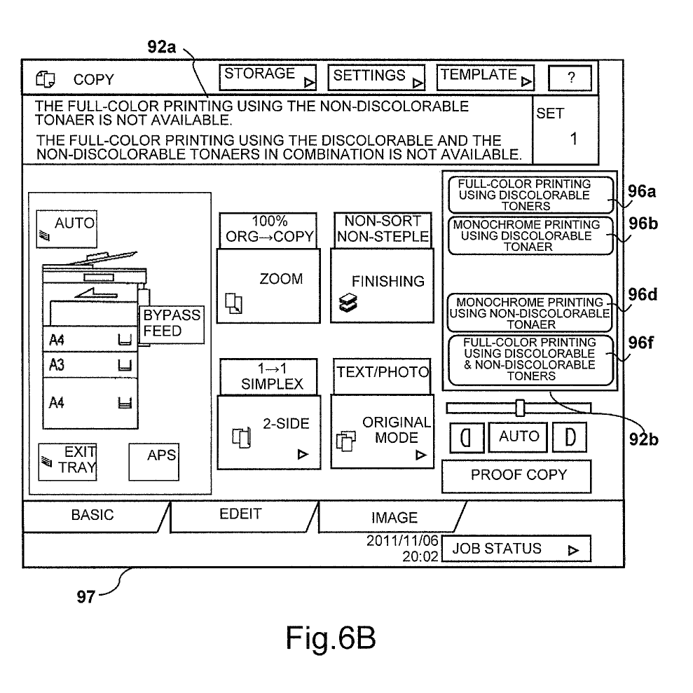

For example, in a case where the residual amount detection unit 30 detects that the residual amounts of the discolorable toners 51a to 51d of the color BK, C, M, and Y and the non-discolorable toners 61a to 61d of the color BK, C, M, and Y are equal to or larger than the predetermined value, the MPU 79 controls the screen display of the display unit 9a as illustrated in FIG. 6A. The display unit 9a displays a first screen 97 illustrated in FIG. 6A.

Similarly to the first screen 91 of FIG. 2A, the first screen 97 includes the message display area 92a and the select button display area 92b. The display unit 9a displays, for example, a message “Printable” in the message display area 92a. The display unit 9a displays select buttons 96a, 96b, 96c, 96d, and 96f in the select button display area 92b. The select button 96a receives a user's selection of the full-color printing using the discolorable toners of four colors. The select button 96b receives a user's selection of the monochrome printing using the discolorable toner of one color. The select button 96c receives a user's selection of the full-color printing using the non-discolorable toners of four colors. The select button 96d receives a user's selection of the monochrome printing using the non-discolorable toner of one color. The select button 96f receives a user's selection of the full-color printing using the discolorable toner and the non-discolorable toner in combination.

In other words, the first screen 97 is a screen through which the user can select any one of the full-color printing using the discolorable toner, the monochrome printing using the discolorable toner, the full-color printing using the non-discolorable toner, the monochrome printing using the non-discolorable toner, and the full-color printing using the discolorable toner and the non-discolorable toner in combination.

For example, the user operates the select button 96a to select the full-color printing using the discolorable toner. Further, when the user operates the start key of the operation panel 9, the MPU 79 controls the full-color image formation, using the discolorable toners of four colors, based on the image data. The image forming unit 3 is controlled by the MPU 79 to perform the full-color forming operation, using the discolorable toners of four colors, based on the image data. Specifically, the first to fourth image forming stations 34a to 34d of the image forming unit 3 forms a full-color image using the discolorable toners 51a to 51d based on the image data. The full-color image formed by the image forming stations 34a to 34d can be discolored, for example, into a transparent color by being heated by the fixing unit 35 at the discoloring temperature. The full-color image formed by the image forming stations 34a to 34d can be erased by being heated by the fixing unit 35 at the erasing temperature.

For example, the user operates the select button 96c to select the full-color printing using the non-discolorable toner. Further, when the user operates the start key of the operation panel 9, the MPU 79 controls the full-color image formation, using the non-discolorable toner, based on the image data. The image forming unit 3 is controlled by the MPU 79 to perform the full-color image formation, using the non-discolorable toners of four colors, based on the image data. Specifically, the fifth to eighth image forming stations 36a to 36d of the image forming unit 3 form a full-color image using the non-discolorable toners 61a to 61d.

In a case where the residual amount detection unit 30 detects that the residual amount of the non-discolorable toner 61c of the color M is less than the predetermined value, and in a case where the residual amount detection unit 30 detects that the residual amounts of the toners 51a to 51d, 61a, 61b, and 61d other than the toner 61c are equal to or larger than the predetermined value, the MPU 79 controls the screen display of the display unit 9a as illustrated in FIG. 9B. The display unit 9a displays a second screen 98 illustrated in FIG. 6B instead of the first screen 97 of FIG. 6A.

Similarly to the first screen of FIG. 2A, the second screen 98 includes the message display area 92a and the select button display area 92b. The display unit 9a displays in the message display area 92a, for example, a message “The full-color printing using the non-discolorable toner is not available. The full-color printing using the discolorable and non-discolorable toners in combination is available”. The display unit 9a displays in the select button display area 92b the select buttons 96a, 96b, 96d, and 96f corresponding to the full-color printing using the discolorable toner, the monochrome printing using the discolorable toner, the monochrome printing using the non-discolorable toner, and the full-color printing using the discolorable toner and the non-discolorable toner in combination, all of which are executable by the MFP 1.

In other words, the second screen 98 is a screen through which the user can select any one printing other than the full-color printing using the non-discolorable toner. For example, the user operates the select button 96d to select the monochrome printing using the non-discolorable toner. Further, when the user operates the start key of the operation panel 9, the MPU 79 controls the monochrome image formation, using the non-discolorable toner other than the toner of the color M, based on the image data. The image forming unit 3 is controlled by the MPU 79 to perform the monochrome image formation, using the non-discolorable toner, based on the image data. Specifically, the image forming station 36a of the image forming unit 3 forms a monochrome image, for example, using the non-discolorable toner 61a based on the image data.

For example, the user operates the select button 96a to select the full-color printing using the discolorable toners. Further, when the user operates the start key of the operation panel 9, the MPU 79 controls the full-color image formation, using the discolorable toners of four colors, based on the image data. The image forming unit 3 is controlled by the MPU 79 to perform the full-color image formation, using the discolorable toners, based on the image data. Specifically, the image forming stations 34a to 34d of the image forming unit 3 forms a full-color image using the discolorable toners 51a to 51d based on the image data. As described above, the full-color image formed by the image forming stations 34a to 34d can be discolored and erased by being heated by the fixing unit 35.

For example, the user operates the select button 96f to select the full-color printing using the discolorable toner and the non-discolorable toner in combination. Further, when the user operates the start key of the operation panel 9, the MPU 79 controls the full-color image formation, using the discolorable toner and the non-discolorable toner in combination, based on the image data. The image forming unit 3 is controlled by the MPU 79 to perform the full-color image formation in which the discolorable toner 51c of the color M of which the residual amount is equal to or larger than the predetermined value, instead of the non-discolorable toner 61c of the color M of which the residual amount is less than the predetermined value. Specifically, the image forming stations 34c, 36a, 36b, and 36d of the image forming unit 3 forms a full-color image using the toners 51c, 61a, 61b, and 61d.

In a case where the residual amount detection unit 30 detects that the residual amount of the non-discolorable toner 61c of the color M is less than the predetermined value, and in a case where the residual amount detection unit 30 detects that the residual amounts of the coloring materials other than the toner 61c are equal to or larger than the predetermined value, the display unit 9a may display in the message display area 92a of the second screen 98 a message giving a recommendation to the user for the full-color printing using the discolorable toner, instead of the full-color printing using the non-discolorable toner.

Further, for example, in a case where the residual amount detection unit 30 detects that the residual amount of the discolorable toner 51c of the color M is less than the predetermined value, and in a case where the residual amount detection unit 30 detects that the residual amounts of the toners other than the toner 51c are equal to or larger than the predetermined value, the MPU 79 controls the screen display of the display unit 9a. The display unit 9a displays in the second screen 98 a message content and select buttons, different from those in the second screen 98 illustrated in FIG. 6B.

Specifically, the display unit 9a displays in the message display area 92a of the second screen 98, for example, a message “The full-color printing using the discolorable toner is not available. The full-color printing using the discolorable and non-discolorable toners are used in combination is available”. The display unit 9a displays in the select button display area 92b the select buttons 96b to 96d, and 96f corresponding to the monochrome printing using the discolorable toner, the full-color printing using the non-discolorable toner, the monochrome printing using the non-discolorable toner, and the full-color printing using the discolorable toner and the non-discolorable toner in combination, all of which are executable by the MFP 1.

In other words, the second screen 98 is changed in its displaying content to be a screen through which the user can select any one printing other than the full-color printing using the discolorable toner.

For example, the user operates the select button 96c to select the full-color printing using the non-discolorable toners. Further, when the user operates the start key of the operation panel 9, the MPU 79 controls the full-color image formation, using the non-discolorable toners of four colors, based on the image data. The image forming unit 3 is controlled by the MPU 79 to perform the full-color image formation, using the non-discolorable toners of four colors, based on the image data. Specifically, the image forming stations 36a to 36d of the image forming unit 3 form a full-color image using the non-discolorable toners 61a to 61d based on the image data.

For example, the user operates the select button 96f to select the full-color printing using the discolorable toner and the non-discolorable toner in combination. Further, when the user operates the start key of the operation panel 9, the MPU 79 controls the full-color image formation, using the discolorable toner and the non-discolorable toner in combination, based on the image data. The image forming unit 3 is controlled by the MPU 79 to perform the full-color image formation using the non-discolorable toner 61c of the color M of which the residual amount is equal to or larger than the predetermined value, instead of the discolorable toner 51c of the color M of which the residual amount is less than the predetermined value. Specifically, the image forming stations 34a, 34b, 34d, and 36c of the image forming unit 3 forms a full-color image using the toners 51a, 51b, 51d, and 61c based on the image data.

Further, for example, in a case where the residual amount detection unit 30 detects that the residual amount of the discolorable toner 51c of the color M is less than the predetermined value, and in a case where the residual amount detection unit 30 detects that the residual amounts of the toners other than the toner 51c are equal to or larger than the predetermined value, the display unit 9a may display in the message display area 92a of the second screen 98 a message giving a recommendation to the user for the full-color printing using the non-discolorable toner, instead of the full-color printing using the discolorable toner.

Further, for example, in a case where the residual amount detection unit 30 detects that the residual amounts of the discolorable toner 51c of the color M and the discolorable toner 51d of Y are less than the predetermined value, and in a case where the residual amounts of the toners other than the toners 51c and 51d are equal to or larger than the predetermined value, the MPU 79 controls the screen display of the display unit 9a. The display unit 9a displays in the second screen 98 a message content and select buttons, different from those in the second screen 98 illustrated in FIG. 6B.

Specifically, the display unit 9a displays in the message display area 92a of the second screen 98, for example, a message “The full-color printing using the discolorable toner is not available. The full-color printing using the discolorable and non-discolorable toners in combination is available”. Further, the display unit 9a displays in the select button display area 92b the select buttons 96b to 96d, and 96f corresponding to the monochrome printing using the discolorable toner, the full-color printing using the non-discolorable toner, the monochrome printing using the non-discolorable toner, and the full-color printing using the discolorable toner and the non-discolorable toner in combination, all of which are executable by the MFP 1.

In other words, the second screen 98 is changed in its displaying content to be a screen through which the user can select any one printing other than the full-color printing using the discolorable toner. For example, the user operates the select button 96f in the second screen 98 to select the full-color printing using the discolorable toner and the non-discolorable toner in combination. Further, when the user operates the start key of the operation panel 9, the MPU 79 controls the full-color image formation, using the discolorable toner and the non-discolorable toner in combination, based on the image data. The image forming unit 3 is controlled by the MPU 79 to perform the full-color image formation using the non-discolorable toner 61c of M of which the residual amount is equal to or larger than the predetermined value instead of the discolorable toner 51c of M of which the residual amount is less than the predetermined value, and using the non-discolorable toner 61d of Y of which the residual amount is equal to or larger than the predetermined value instead of the discolorable toner 51d of Y of which the residual amount is less than the predetermined value. Specifically, the image forming stations 34a, 34b, 36c, and 36d of the image forming unit 3 forms a full-color image using the toners 51a, 51b, 61c, and 61d based on the image data.

As described above, in the third embodiment, in a case where the insufficiency in the residual amount of one or more toners from among the eight toners 51a to 51d, and 61a to 61d is detected, the MFP 1 forbids the print mode using the toner insufficient in the residual amount, and allows the print mode not using the toner insufficient in the residual amount. Further, the MFP 1 performs the full-color image formation not using the discolorable toner (for example, the discolorable toner of the color Y) insufficient in the residual amount, but instead using the non-discolorable toner of the similar color (for example, the non-discolorable toner of the color Y), or not using the non-discolorable toner (for example, the non-discolorable toner of the color Y) insufficient in the residual amount, but instead using the discolorable toner of the similar color (for example, the discolorable toner of the color Y). Therefore, the MFP 1 performs the image formation using an alternative toner not insufficient in the residual amount even when the insufficiency in the residual amount of any one of the discolorable toner and the non-discolorable toner is detected. Accordingly, it is possible to improve a decrease in processing efficiency.

In a case where the MFP 1 performs the full-color printing using the discolorable toner and the non-discolorable toner in combination, the MPU 79 may be configured to perform an image correcting operation according to the color property of a using toner. For example, the discolorable toners 51b to 51d of the color C, M, and Y and the non-discolorable toners 61b to 61d of the color C, M, and Y are not limited to have exactly the same colors. In a case where the discolorable toner and the non-discolorable toner do not have exactly the same color, the MPU 79 holds color information of the discolorable toners 51b to 51d of the color C, M, and Y and the non-discolorable toners 61b to 61d of the color C, M, and Y in advance, and performs the image correcting operation based on the color information.

For example, the toner or ink which is the discolorable coloring material includes the coloring compound, the developing agent, the binder resin, and the like as described above. When the coloring material in a state where the coloring compound develops a color by the action of the developing agent is heated to a predetermined temperature, the binder resin is cured, and the developing agent generally becomes easy to move from the inside of the binder resin to the front face so as to move and/or diffuse into the paper. Therefore, the coloring compound is not influenced by the action of the developing agent, such that the color of the coloring compound cannot be recognized by the user.

The coloring compound is a precursor compound of the pigment that forms the image. As the coloring compound, for example, it is preferable to use an electron donor organic material such as leukoauramines, diarylphthalides, polyarylcarbinols, acylauramines, arylauramines, rhodamine B lactams, indolines, spiropyrans, or fluorans.

The developing agent is a compound that develops the color of the coloring compound based on an interaction (mainly, transmission/reception of electrons or protons) with the coloring compound. As the developing agent, for example, it is preferable to use phenols, phenol metal salts, carboxylic metal slats, benzophenones, sulfonic acid, sulfonate, phosphorus acids, phosphate metal salts, acidic phosphate ester, acidic phosphate ester metal salts, phosphorous acids, or phosphorous acid metal salts and the like.

The binder resin disperses the coloring compound and the developing agent in the state in which the color is developed. As the binder resin, it is preferable to use a material that is compatible with the coloring compound by being applied with constant heating and does not have affinity to the developing agent.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit configured to house a plurality of coloring materials including a discolorable coloring material, and forms an image using at least one coloring material from among the plurality of coloring materials;
a detection unit configured to detect whether the residual amounts of the plurality of housed coloring materials are less than a predetermined value; and
a control unit configured to, in a case where the detection unit detects that the residual amount of at least one discolorable coloring material from among the plurality of coloring materials is less than the predetermined value, control an image formation of the image forming unit such that the image forming unit forms an image using another coloring material other than the coloring material of which the residual amount is less than the predetermined value.

2. The image forming apparatus according to claim 1,
wherein the plurality of coloring materials include coloring materials of a plurality of colors,
wherein the image forming unit is configured to perform a color image formation using the coloring materials of the plurality of colors, and a single-color image formation using one coloring material from among the coloring materials of the plurality of colors, and
wherein, in a case where the detection unit detects that the residual amount of at least one discolorable coloring material is less than the predetermined value, the control unit forbids the color image formation and allows the single-color image formation using another coloring material other than the coloring material, of which the residual amount is less than the predetermined value.

3. The image forming apparatus according to claim 2,
wherein the coloring materials of the plurality of colors include a first discolorable coloring material and a second discolorable coloring material which are discolored by being heated, and
wherein, in a case where the detection unit detects that the residual amount of the first discolorable coloring material is less than the predetermined value, the control unit allows the single-color image formation using the second discolorable coloring material.

4. The image forming apparatus according to claim 3,
wherein the first discolorable coloring material and the second discolorable coloring material are coloring materials different from each other in color, and
wherein the first and second discolorable coloring materials are coloring materials which are discolored to be a transparent color by being heated.

5. The image forming apparatus according to claim 1,
wherein the plurality of coloring materials include a discolorable coloring material of a first color, a discolorable coloring material of a second color, a discolorable coloring material of a third color, and a discolorable coloring material of a fourth color,
wherein the image forming unit is configured to perform a color image formation using the discolorable coloring material of the first color, the discolorable coloring material of the second color, the discolorable coloring material of the third color, and the discolorable coloring material of the fourth color, and to perform a single-color image formation using at least one discolorable coloring material from among the discolorable coloring materials of the first to fourth colors, and
wherein, in a case where the detection unit detects that the residual amount of at least one coloring material from among the discolorable coloring material of the first color, the discolorable coloring material of the second color, and the discolorable coloring material of the third color is less than the predetermined value, the control unit forbids the color image formation, and allows the single-color image formation.

6. The image forming apparatus according to claim 1,
wherein the plurality of coloring materials include a non-discolorable coloring material, and
wherein, in a case where the detection unit detects that the residual amount of at least one discolorable coloring material is less than the predetermined value, the control unit allows an image formation using the non-discolorable coloring material of which the residual amount is not less than the predetermined value.

7. The image forming apparatus according to claim 6,
wherein, in a case where the detection unit detects that the residual amount of at least one non-discolorable coloring material is less than the predetermined value, the control unit allows an image formation using the discolorable coloring material of which the residual amount is not less than the predetermined value.

8. The image forming apparatus according to claim 1,
wherein the plurality of coloring materials include discolorable coloring materials of a plurality of colors and non-discolorable coloring materials of a plurality of colors,
wherein the image forming unit is configured to perform a first color image formation using the discolorable coloring materials of the plurality of colors, and a second color image formation using the non-discolorable coloring materials of the plurality of colors, and
wherein, in a case where the detection unit detects that the residual amount of at least one coloring material from among the discolorable coloring materials of the plurality of colors is less than the predetermined value, the control unit forbids the first image formation, and allows the second image formation.

9. The image forming apparatus according to claim 8,
wherein, in a case where the detection unit detects that the residual amount of one coloring material from among the non-discolorable coloring materials of the plurality of colors is less than the predetermined value, the control unit forbids the second image formation, and allows the first image formation.

10. The image forming apparatus according to claim 8,
wherein the control unit is configured to perform a third color image formation using any coloring material from among the discolorable coloring materials of the plurality of colors and any coloring material from among the non-discolorable coloring materials of the plurality of colors in combination, and
wherein, in a case where the detection unit detects that the residual amount of at least one coloring material from among the discolorable coloring materials of the plurality of colors is less than the predetermined value, the control unit allows the third image formation using the discolorable coloring materials other than the coloring material of which the residual amount is less than the predetermined value and the non-discolorable coloring materials of the similar color as the coloring material of which the residual amount is less than the predetermined value in combination.
